(19) United States
(12) Patent Application Publication
(10) Pub. No.: US 2026/0179527 A1
(43) Pub. Date: Jun. 25, 2026

(54) DYNAMIC POWER DELIVERY FOR A DISPLAY PANEL BASED ON CONTENT BRIGHTNESS

(71) Applicant: Intel Corporation, Santa Clara, CA (US)

(72) Inventors: Arvind Singh Tomar, Folsom, CA (US); Krishna Kishore Nidamanuri, Bangalore (IN); Perazhi Sameer Kalathil, Folsom, CA (US); Roland P. Wooster, Folsom, CA (US); Geethacharan Rajagopalan, Gold River, CA (US); Susanta Bhattacharjee, Bangalore (IN); Vishal Ravindra Sinha, Portland, OR (US); Kunjal S. Parikh, Fremont, CA (US); Soorya Ramesh, Bangalore (IN)

(73) Assignee: Intel Corporation, Santa Clara, CA (US)

(21) Appl. No.: 19/001,121

(22) Filed: Dec. 24, 2024

(51) Int. Cl. G09G 3/20; G09G 3/3208; G09G 3/36

(52) U.S. Cl. CPC G09G 3/2096; G09G 3/3208; G09G 3/36; G09G 2330/021

(57) ABSTRACT

Devices, systems, and methods for dynamic power delivery for a display panel based on content brightness are disclosed herein. In one example, an electronic device includes a display panel and control circuitry. The control circuitry receives a sequence of frames, which includes multiple frames that are to be displayed sequentially on the display panel. In addition, the control circuitry dynamically adjusts a power level for the display panel based on brightness data for the sequence of frames.

### BACKGROUND

Many modern display panels support high dynamic range (HDR), which is a technology that enables videos and images to be represented using a wider range of brightness, contrast, and color. Due to high power overhead, however, many systems with HDR-capable display panels are configured with HDR mode disabled by default. As a result, users are required to manually enable HDR mode to realize its benefits. Moreover, when HDR mode is enabled, the display panels consume significant power, even when only non-HDR content is being displayed (e.g., standard dynamic range (SDR) content), which reduces the battery life of mobile systems.

### BRIEF DESCRIPTION OF THE DRAWINGS

FIG. 1 illustrates a system with dynamic power delivery for a display panel based on content brightness.

FIG. 2 illustrates an implementation of dynamic voltage scaling for a display panel based on content brightness.

FIG. 3 illustrates an implementation of dynamic duty cycle scaling for a display panel based on content brightness.

FIG. 4 illustrates an example of dynamic power delivery for a display panel based on content brightness.

FIG. 5 illustrates a process flow for communicating content brightness to a sink device.

FIG. 6 illustrates a process flow for dynamically scaling the power level of a display panel based on content brightness.

FIG. 7 illustrates an example computing system.

FIG. 8 illustrates an example processor unit.

### DETAILED DESCRIPTION

Many modern display panels support high dynamic range (HDR), which is a technology for representing videos and images using a wider range of brightness, contrast, and color compared to standard dynamic range (SDR). For example, HDR expands the range of brightness levels to support brighter whites and deeper blacks. HDR also supports a broader color gamut (e.g., often using 10-bit color or higher compared to 8-bit color in SDR), which results in more vivid colors. As a result, HDR enables videos and images to appear more realistic and vibrant, similar to what the human eye perceives in the real world, which results in a better user experience.

However, many HDR-capable mobile systems ship with HDR disabled by default (at least when running on battery power) due to high power overhead. As a result, the user must manually enable HDR mode to realize its benefits, which means only users who are aware of this can enjoy the benefits of HDR. The primary reason HDR is disabled by default in these systems is due to the incremental power consumption in HDR mode even when only SDR content is being displayed, such as productivity (e.g., desktop) applications and webpages.

In particular, the brightness or intensity of light emitted from a display is referred to as luminance, which is measured in “nits,” or candelas per square meter (cd/m²), where candelas are a unit of luminous intensity or brightness. SDR content typically has peak luminance of 100-400 nits, while HDR content may have peak luminance of 1,000-4,000 nits and even as high as 10,000 nits.

When HDR mode is enabled, the display panel switches into a power delivery mode that supports higher luminance, or brightness, to match the maximum potential luminance of video frame content, regardless of whether the content actually requires high luminance. To support this higher luminance mode, the display panel needs more current to drive its pixels, which in turn requires higher voltage, often from a separate power delivery mechanism. As a result, the timing controller (TCON) for the display panel switches to a higher-voltage power delivery setting (e.g., higher-voltage power rail or higher duty cycle) for HDR mode compared to SDR mode, even if the pixels in the content being displayed are no brighter than standard SDR “paper white.”

Switching to higher voltage in HDR mode even when only low-luminance content is being displayed does not improve the user experience-rather, it increases power consumption and reduces battery life. For example, on an organic light-emitting diode (OLED) display panel in HDR mode with only SDR content being displayed, an average increase of up to 700 milliwatts (mW) of electroluminescence (EL) power may be required, which translates to about a 25% increase in power consumption and 5% reduction in battery life. This increase in OLED EL power in HDR mode occurs because the display panel switches to higher voltage to drive the higher brightness levels supported by HDR. Once in HDR mode, the display panel continues operating at the higher voltage even when displaying low-luminance SDR content, which results in the 25% increase in power consumption.

As an example, for a notepad application with peak luminance of about 250 nits on an OLED display, SDR mode consumes about 4 watts (W) of EL power, while HDR mode consumes about 5 W of EL power for the same content, thus increasing power consumption by 1 W in HDR mode, which can significantly reduce battery life.

On other display technologies, such as liquid crystal display (LCD), the increase in power consumption in HDR mode versus SDR mode is comparable to OLED and may even be higher in some cases.

Accordingly, this disclosure presents embodiments of dynamic power delivery for a display panel based on content brightness. For example, the described solution enables a display to dynamically scale its power level (e.g., operating voltage or duty cycle) while in HDR mode, thus incurring the power-related cost for high brightness only for HDR content that actually requires it, while otherwise running at low power to reduce power consumption. In this manner, the impact on power consumption is minimal when non-HDR content is displayed in HDR mode. As a result, HDR mode can be enabled by default on mobile systems, allowing users to enjoy the benefits of HDR without the drawbacks of higher power consumption and reduced battery life when viewing non-HDR content.

In some embodiments, for example, metadata is provided to the display timing controller (TCON) indicating the maximum brightness of video content at a particular granularity (e.g., per frame or N consecutive frames), which allows the display to scale power delivery in real time based on the brightness of the content being displayed. For example, using the brightness metadata, an OLED display can dynamically switch between different operating voltages for its EL power rail, while an LCD display can dynamically adjust the pulse-width modulation (PWM) duty cycle for its backlight. In this manner, the power required for high-brightness content is delivered only when necessary, and power consumption is reduced for content that does not require high brightness.

For example, for a frame that contains high-brightness HDR content, the display can dynamically switch to a higher-power mode (e.g., higher voltage or duty cycle) to provide the requisite luminance when the frame is displayed. Conversely, for a frame that contains content with lower brightness requirements (e.g., SDR content, HDR content with SDR-level brightness, or HDR content with brightness that can be supported with lower power), the display can dynamically switch to a lower-power mode (e.g., lower voltage or duty cycle) to conserve power.

In some embodiments, the brightness metadata or “hints” may be provided by a video source device (e.g., host computing device) to a video sink device (e.g., display device), enabling the sink device to consume the hints and adjust the luminance/brightness of its display panel in flicker-free fashion. In this manner, the power/brightness scaling functionality can be controlled or driven by the source device that provides the brightness hints to the sink device. This disclosure also presents algorithms for determining the maximum brightness requirement of video content by the source device, along with an interface for communicating this information to the sink device.

The described embodiments may provide various advantages. By providing the display panel with information about the content being displayed, the display panel no longer has to statically operate at the highest power level in HDR mode-instead, the display panel can dynamically scale power and brightness based on the content itself. When displaying content with SDR luminance (or lower) in HDR mode, power consumption by the display panel is no higher than when in SDR mode, as the power delivery/brightness control mechanism of the display panel is driven at the same (or lower) power and luminance levels as SDR mode. In this manner, when HDR mode is enabled, less power is consumed when displaying SDR content (or other non-HDR content) compared to HDR content. HDR mode is now on par with SDR mode with respect to power consumption for non-HDR content (e.g., SDR content), such as operating system (OS)/desktop user interface (UI), productivity applications such as email and word processing, web browsing, etc. Moreover, power consumption can be significantly reduced (e.g., by at least 25% in some cases) for HDR content that does not make use of higher brightness.

In this manner, HDR content and applications (e.g., movies, games) can utilize the full range of brightness and color supported by HDR when needed (and at lower power for HDR content that does not require maximum brightness), while non-HDR content (e.g., OS/desktop UI, productivity applications, webpages) can be displayed at SDR power and luminance levels (or lower). Thus, overall power consumption is reduced without any reduction in quality for displayed video content.

As a result, the legacy process of manually switching between SDR mode and HDR mode can be abandoned, and instead HDR mode can be enabled by default, or enabled permanently, on all devices, as the HDR power overhead for non-HDR content is minimal.

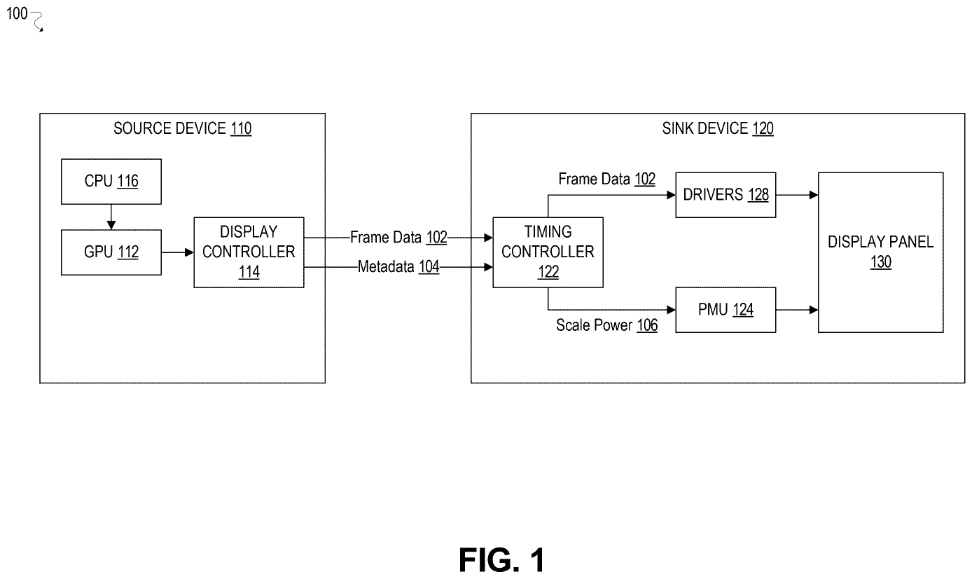

FIG. 1 illustrates an example system 100 with dynamic power delivery for a display panel 130 based on content brightness. In the illustrated embodiment, system 100 includes a source device 110 and a sink device 120. The source device 110 provides frame data 102 and associated brightness metadata 104 to the sink device 120, and the sink device 120 dynamically or continuously scales the power level of an associated display panel 130 based on the brightness, or luminance, of content within pending frames 102, as indicated by the brightness metadata 104. In this manner, when pending frames 102 in the pipeline are subsequently displayed, the display panel 130 will have enough power to support the brightness of the content in those frames 102, without consuming more power than necessary.

A display system 100 typically includes a source device 110 and a sink device 120, where the source device 110 provides frames 102 (e.g., pixel data for images/video) to the sink device 120 for display, and the sink device 120 processes and displays the incoming frames 102 on an associated display panel 130.

The sink device 120 may be implemented in any display device, meaning any device with a display panel 130, such as a monitor, television, projector, immersive reality headset (e.g., augmented reality (AR) and/or virtual reality (VR)), or embedded-display device such as a mobile device (e.g., laptop, mobile phone, tablet, smart watch). The source device 110 may be implemented in any electronic device or system designed to interface with a sink device 120, such as a computer, mobile device (e.g., laptop, cellular phone, tablet, smart watch), video game console, media player, set-top box, or display device. In various embodiments, the source and sink devices 110, 120 may be implemented in physically separate devices (e.g., a desktop computer as the source device 110 and a monitor as the sink device 120) or integrated within the same device (e.g., a smart television, laptop, mobile phone, tablet, smart watch).

In the illustrated embodiment, the source device 110 includes a central processing unit (CPU) 116, a graphics processing unit (GPU) 112, and a display controller 114. The CPU 116 may execute an operating system (OS) and/or one or more applications, which may utilize the GPU 112 for a variety of graphics processing tasks, including processing/display of frames 102 on the display panel 130. The GPU 112 receives image and/or video data (e.g., from CPU 116 or another source) and generates corresponding frame data 102, which represents the image/video data in a format that can be displayed on a display panel 130. The display controller 114 handles synchronization (e.g., horizontal (HSYNC) and vertical (VSYNC) synchronization signals, pixel clocks, refresh rates), frame formatting (e.g., color space, resolution), and transmission of frame data 102 between the source device 110 and the sink device 120. Moreover, the GPU 112 and/or the display controller 114 may store frame data 102 in a frame buffer.

In the illustrated embodiment, the sink device 120 includes a timing controller (TCON) 122, a power management unit (PMU) 124, drivers 128, and a display panel 130. The TCON 122 synchronizes the source device 110 and the display panel 130 (e.g., synchronized refresh rate), receives and decodes incoming frames 102 from the source device 110, and coordinates the display of decoded frames 102 on the display panel 130 (e.g., using row/column drivers 128). The PMU 124 controls the supply and delivery of power (e.g., voltage, current, duty cycle, etc.) to the various components of the sink device 120, including the power needed to drive the display panel 130. The drivers 128 control the rows and columns of the display panel 130. For example, the drivers 128 may include source drivers (also referred to as column drivers) to control columns of the display panel 130 and gate drivers (also referred to as row drivers) to control rows of the display panel 130. The display panel 130 is used to display a visual representation of the respective frames 102 based on the coordination from the TCON 122 (e.g., using an array of pixels).

In the illustrated embodiment, the GPU 112 generates frame data 102 and associated brightness metadata 104 (e.g., based on requests/instructions from the OS and/or applications executing on the CPU 116).

In some embodiments, the brightness metadata 104 may indicate the content type and/or peak brightness for a sequence of one or more pending frames 102 (e.g., a rolling window of N consecutive frames 102 that are next to be displayed). For example, the content type may indicate a category of content detected within the frames 102 (e.g., movie, video game, desktop productivity application, etc.), an overall level of brightness associated with the detected frame content 102 (e.g., high brightness, moderate brightness, low brightness, SDR or HDR level brightness, etc.), or any other suitable characterization of the type of content detected in the frames 102. Moreover, the peak brightness may indicate the maximum pixel brightness for the pixels in the sequence of pending frames 102.

The GPU 112 sends the frame data 102 and metadata 104 to the display controller 114, which transmits the same to the TCON 122 on the sink device 120 (e.g., using in-band, side-band, or out-of-band messaging).

The TCON 122 determines a target power level (e.g., operating voltage, duty cycle, etc.) for the display panel 130 based on the brightness metadata 104. In some embodiments, for example, the PMU 124 may support multiple power levels for defined ranges of brightness or luminance. Thus, the TCON 122 may select a target power level based on the peak brightness of one or more pending frames, as indicated in the brightness metadata 104. The TCON 122 may then send an instruction 106 to the PMU 124 to dynamically scale the power level of the display panel 130 to the target power level.

The TCON 122 also provides corresponding frame data 102 to the source/gate (row/column) drivers 128, which control the rows and columns of pixels on the display panel 130 to cause the sequence of frames 102 to be displayed on the display panel 130. In this manner, when the pending frames 102 are subsequently displayed, the display panel 130 will have enough power to support the pixel brightness in those frames 102, without consuming more power than necessary. In particular, the power level is dynamically scaled based on a defined brightness/power-level curve, such that the minimum power level capable of supporting the content brightness of the pending frames 102 is delivered to the display panel 130 for display of those frames 102. This results in significant power savings, particularly when displaying non-HDR (e.g., low brightness) content in HDR mode (e.g., increasing battery life by 25% in some cases). As a result, HDR mode can be defaulted to always on without impacting battery life.

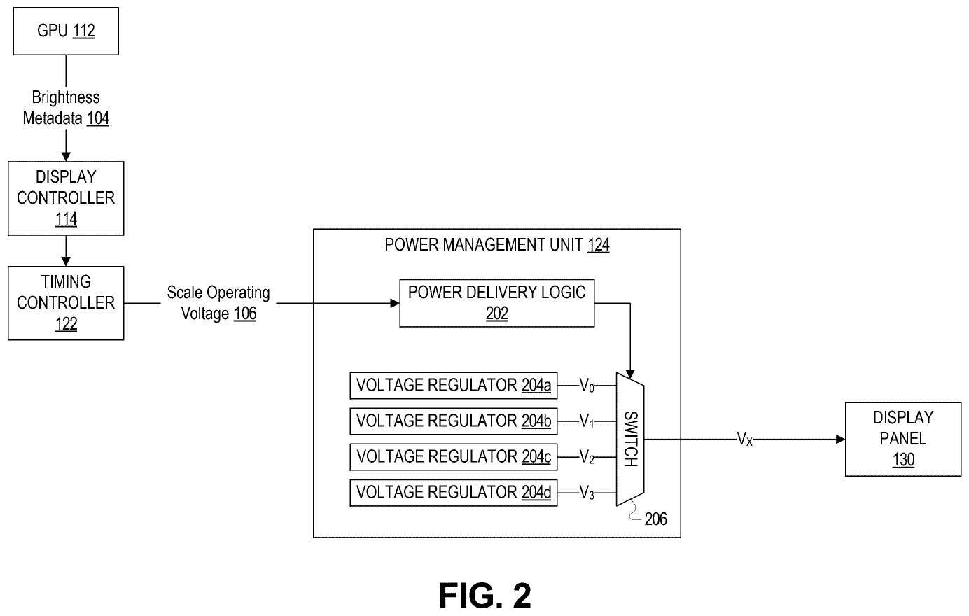

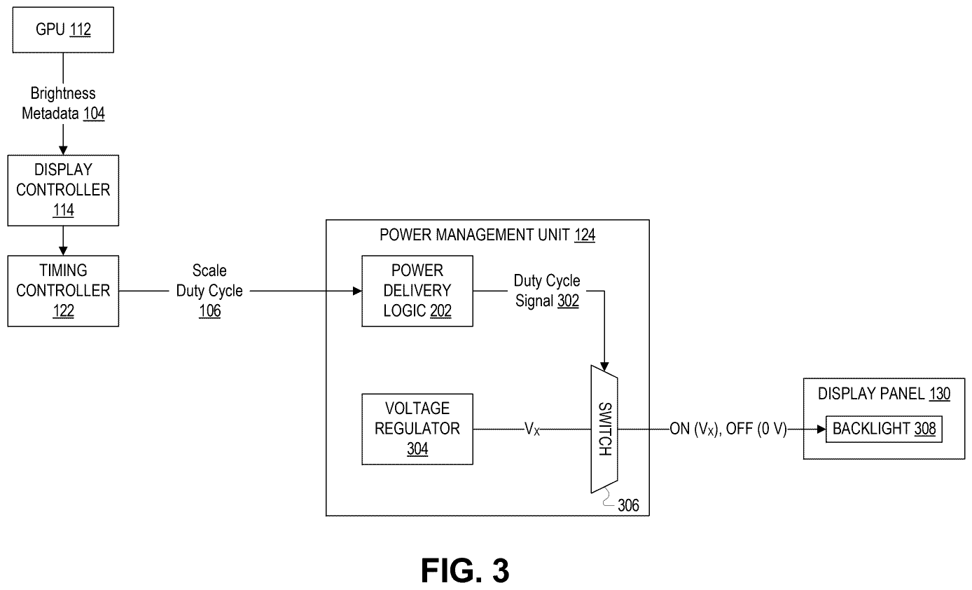

More detailed implementations of dynamic voltage scaling (e.g., for OLED display panels) and dynamic duty cycle scaling (e.g., for LCD display panels) are presented below in connection with FIG. 2 and FIG. 3, respectively.

The display panel 130 may include any type of display panel on which information may be displayed, such as a light-emitting diode (LED) display, an organic LED (OLED) display, a micro-LED display, a liquid crystal display (LCD), or a display based on any other display technology.

System 100, and source/sink devices 110, 120, may be implemented using any type or combination of electronic devices or systems (e.g., integrated circuits, processing units, systems on chip (SoCs), etc.). System 100, source and sink devices 110, 120, and their respective components may be implemented using any type or combination of circuitry, including processing circuitry and/or control circuitry to implement their respective functionality, interface circuitry for communication among the respective components and/or other components (e.g., over a network), etc. Source device 110 and its respective components may be collectively referred to as source circuitry, and sink device 120 and its respective components may be collectively referred to as sink circuitry. In some embodiments, the source/sink devices 110, 120 may be part of an embedded display device (e.g., embedded within the same device and connected to each other via an embedded display port (eDP)).

As used herein, “dynamically” means in real time, during operation, continuously, and/or periodically (e.g., as pending frames 102 are processed and displayed). Brightness metadata 104 may also be referred to as brightness data, brightness hints, luminance metadata, luminance data, luminance hints, or other similar variations thereof.

It should be appreciated that system 100 is merely an example embodiment and numerous other embodiments are also within the scope of this disclosure. In various embodiments, for example, certain components of system 100 may be modified, replaced, rearranged, omitted, and/or added. In some embodiments, the display controller 114 may be integrated as part of the GPU 112. In some embodiments, the source device 110 may include a display engine instead of, or in addition to, a GPU 112 and/or a display controller 114. In some embodiments, system 100 (or source/sink devices 110, 120) may include other or additional components, such as those commonly found in a computing device or system. For example, system 100 (or source/sink devices 110, 120) may include memory, storage devices, communication interfaces, peripheral or input/output (I/O) devices (e.g., keyboard, mouse, speaker, microphone, camera, battery), etc.

FIG. 2 illustrates an example implementation of dynamic voltage scaling for a display panel 130 based on content brightness. In some embodiments, for example, the display panel 130 may be an OLED display panel, and the operating voltage for the electroluminescence (EL) pixels of the OLED display panel 130 may be dynamically scaled based on content brightness.

In the illustrated example, brightness metadata 104 for a pending frame 102 (or sequence of pending frames 102) is transmitted from the GPU 112 to the display controller 114, and then to the timing controller (TCON) 122. Based on the brightness metadata 104 (e.g., the content type and/or maximum pixel brightness), the TCON 122 sends an instruction 106 to power delivery logic 202 in the PMU 124 to scale the operating voltage of the display panel 130 to a target voltage (Vₓ). In response, the power delivery logic 202 scales the operating voltage of the display panel 130 to the target voltage (Vₓ). In this manner, the display panel 130 consumes enough power to support the peak brightness/luminance of the pending frame(s) 102 that will be displayed, without consuming more power than needed.

In particular, the PMU 124 includes multiple voltage regulators 204a-d that support different operating voltages (V₀, V₁, V₂, V₃), which are supplied as input to a switch 206. The power delivery logic 202 sends a signal to the switch 206 to select the target operating voltage (Vₓ) identified in the instruction 106 from the TCON 122. In this manner, the operating voltage of the display panel 130 is scaled to the target voltage, which enables the display panel 130 to support the peak luminance of the pending frame(s) 102 that will be displayed.

As an example, for an OLED display panel 130, the concept of electroluminescence (EL) is used to produce light, where electroluminescent materials (e.g., organic compounds) emit light when electric current passes through them. In particular, each OLED pixel is a self-emissive electroluminescent unit, with an organic layer sandwiched between two electrodes. When current flows through the electrodes, the organic layer emits light directly. As a result, no backlight is needed for an OLED display 130.

An OLED display typically includes an EL power rail to supply the requisite operating voltage to power the pixels. In current OLED displays, the EL power rail supports two operating voltages, low voltage and high voltage, where low voltage is supplied in SDR mode and high voltage is supplied in HDR mode, regardless of the actual brightness of the content being displayed. As a result, in HDR mode, high voltage is supplied even when non-HDR content with low brightness is being displayed (e.g., where a lower voltage would suffice), thus wasting power and draining battery life.

In the illustrated embodiment, however, more than two EL operating voltages are supported for the OLED display panel 130, and the target operating voltage is dynamically selected based on the actual brightness of the content being displayed, rather than statically selected based on the current display mode (e.g., SDR mode vs. HDR mode), thus improving power efficiency.

For example, the target voltage for a particular frame (or sequence of frames) is selected based on the peak luminance of the frame content, which means the power consumption for displaying that frame (or sequence of frames) will be the same in SDR mode versus HDR mode. In this manner, significant power savings are achieved in HDR mode when displaying content with luminance levels below the maximum.

In some embodiments, for example, multiple operating voltages (V₀-V₃) may be supported for defined ranges of brightness or luminance, such as voltage V₀ for brightness of 0-250 nits, voltage V₁ for brightness of 251-620 nits, voltage V₂ for brightness of 621-1000 nits, and voltage V₃ for brightness beyond 1000 nits. Moreover, the target operating voltage may be selected based on the maximum pixel brightness of a pending frame or sequence of pending frames, as indicated in the brightness metadata 104. For example, voltage V₀ may be selected for a maximum pixel brightness of 200 nits, while voltage V₂ may be selected for a maximum pixel brightness of 900 nits.

While four operating voltages (V₀-V₃) are shown in the illustrated example, any number of operating voltages may be supported in actual embodiments (e.g., depending on the maximum brightness supported by the particular display panel 130).

In some embodiments, various approaches may be used to avoid or reduce flicker when scaling the operating voltage for a display panel 130. For example, for a current driven device like an OLED display panel 130, the panel operating point for fixed brightness can be preserved by changing the dynamic scale of the EL voltage rails by modulating the current while keeping the operating region within the saturation region, without producing flicker or other visual artifacts on the display. This requires the voltages at the drain (V_{DD}) and source (V_{SS}) level of the thin-film transistors (TFTs) in the OLED panel 130 to change in order to ensure the same amount of current is driven for the same brightness level. While keeping the operating point in the TFT saturation region, there is an opportunity to ensure the same current level when the voltage rails (V_{DD}, V_{SS}) are shifted for different brightness levels. To accomplish this, the TFT “kink effect” should be well controlled, which is a function of the gate length. A wider gate length allows better saturation curves, which helps avoid any changes to current, and hence brightness level, between frames. This results in “flicker-free” operation without any visual artifacts upon shifting the voltage rail.

FIG. 3 illustrates an example implementation of dynamic duty cycle scaling for a display panel 130 based on content brightness. In some embodiments, for example, the duty cycle for a backlight 308 of a display panel 130 may be dynamically scaled based on content brightness. In some embodiments, the display panel 130 may be an LCD display panel, which uses pulse-width modulation (PWM) to control the duty cycle of the backlight 308.

In the illustrated example, brightness metadata 104 is transmitted from the GPU 112 to the display controller 114, and then to the timing controller (TCON) 122. The TCON 122 sends an instruction 106 to power delivery logic 202 in the PMU 124 to scale the duty cycle of the backlight 308 of the display panel 130. In response, the power delivery logic 202 adjusts the duty cycle signal 302 to change the amount of time the backlight 308 is on during each cycle, which effectively controls the brightness of the display panel 130.

In particular, the duty cycle signal 302 is provided as input to a switch 306, along with a voltage (Vₓ) supplied from a voltage regulator 304. When the duty cycle signal 302 is “ON,” the switch 306 supplies the voltage (Vₓ) to the backlight 308. When the duty cycle signal 302 is “OFF,” no voltage (0 V) is supplied to the backlight 308. In this manner, the duty cycle signal 302 controls when the voltage (Vₓ) is supplied to the backlight 308.

As an example, an LCD display panel 130 typically uses pulse-width modulation (PWM) for backlight control. In particular, a PWM signal 302 can be used to control the duty cycle for the backlight 308 of the LCD display 130, which refers to the percentage of time the LCD backlight 308 is turned on during each PWM cycle. In this manner, the PWM duty cycle signal 302 controls the brightness of the LCD display panel 130 by adjusting the amount of light emitted from the backlight 308 without changing the supplied voltage. As a result, the PWM duty cycle signal 302 effectively controls the average voltage supplied to the LCD backlight 308 (e.g., based on the percentage of time the voltage is ON versus OFF during each cycle).

For example, the duty cycle refers to the ratio of time “on” to the total cycle time:

$$Duty Cycle ( \% ) = \frac{Time On}{Total Cycle} * 100$$

A higher duty cycle means the backlight 308 is on for a longer period of time during each cycle, thus increasing brightness. A lower duty cycle means the backlight 308 is on for a shorter period of time during each cycle, thus decreasing brightness (e.g., dimming the display panel 130). As an example, a duty cycle of 100% means the backlight 308 is always on, which results in maximum brightness. A duty cycle of 50% means the backlight 308 is on for half the cycle and off for the other half, which results in medium brightness. A duty cycle of 0% means the backlight 308 is always off, which results in a dark screen or no brightness.

In the illustrated embodiment, the duty cycle for the backlight 308 is dynamically scaled based on the actual brightness of the content being displayed. In some embodiments, for example, the duty cycle may be scaled proportionally based on the maximum brightness of the content being displayed and the maximum brightness supported by the display panel 130:

$$Duty Cycle ( \% ) = \frac{Maximum Pixel Brightness}{Maximum Supported Brightness} * 100$$

For example, for a display panel 130 that supports a maximum brightness of 1000 nits and a pending frame (or sequence of pending frames) with a maximum pixel brightness of 500 nits, a 50% duty cycle may be used (e.g., (500 nits/1000 nits)*100)=50%).

Alternatively, multiple duty cycles may be supported for defined ranges of brightness or luminance, such as a duty cycle of 25% for brightness of 0-250 nits, a duty cycle of 50% for brightness of 251-620 nits, a duty cycle of 75% for brightness of 621-1000 nits, and a duty cycle of 100% for brightness beyond 1000 nits.

In this manner, the target duty cycle for the backlight 308 may be selected based on the maximum pixel brightness of a pending frame (or sequence of pending frames), as indicated in the brightness metadata 104. For example, for a display panel 130 with a maximum supported brightness of 1000 nits, a duty cycle of 25% may be used for a maximum pixel brightness of 250 nits, while a duty cycle of 75% may be used for a maximum pixel brightness of 750 nits.

In some embodiments, an LCD display panel 130 may include multiple backlights 308 for different regions of the panel 130. In those embodiments, the brightness metadata 104 may indicate the maximum pixel brightness for each region of a frame 102 corresponding to a particular backlight 308. In this manner, dynamic duty cycle scaling can be performed independently for each backlight 308. For example, the duty cycle of each backlight 308 can be independently scaled based on the content brightness within the corresponding region of the display panel 130.

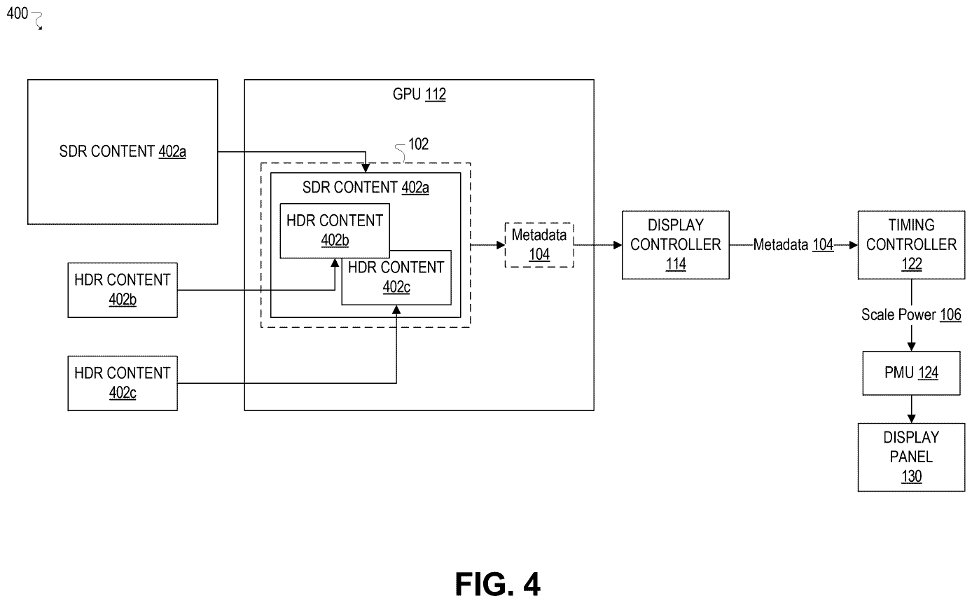

FIG. 4 illustrates an example 400 of dynamic power delivery for a display panel 130 based on content brightness. In the illustrated example, multiple layers of content 402a-c from different sources are received by the GPU 112 (e.g., from the CPU 116) and then composited into a single frame 102 to be displayed on the display panel 130. In particular, the respective layers of content 402a-c include a layer of SDR content 402a and multiple layers of HDR content 402b,c. As an example, the SDR content 402a may be from a productivity application (e.g., email, word processing, web browser), and the HDR content 402b,c may be from a movie and/or a video game.

After the GPU 112 composites the layers of content 402a-c into a single frame 102 (e.g., stored in a framebuffer), the GPU 112 determines brightness metadata 104 for the composited frame 102 (e.g., either for the frame 102 in its entirety or for each layer of content 402a-c in the frame 102). In some embodiments, for example, the brightness metadata 104 indicates the content type and the maximum pixel brightness of content within the frame 102.

The GPU 112 sends the brightness metadata 104 to the display controller 114, which in turn sends the same to the timing controller (TCON) 122. Based on the brightness metadata 104, the TCON 122 sends an instruction 106 to the PMU 124 to scale the power level of the display panel 130, and in response, the PMU 124 dynamically scales the power level of the display panel 130.

In some embodiments, for example, the PMU 124 may scale an operating voltage of the display panel 130 (e.g., for an OLED display 130), a duty cycle of the display panel 130 (e.g., for an LCD display 130), or any other power-level setting. In this manner, when the frame 102 is subsequently displayed on the display panel 130, the display panel 130 will be operating at the requisite power level to support the maximum brightness or luminance of the frame 102.

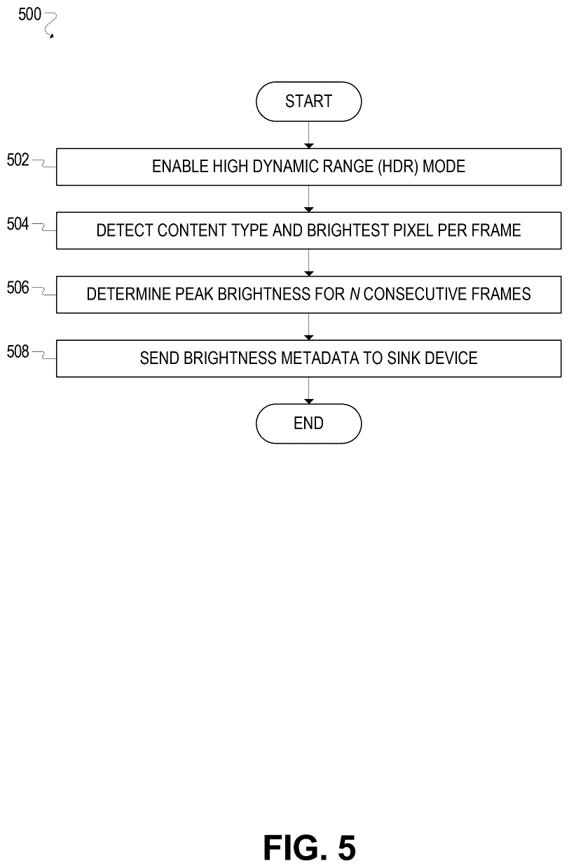

FIG. 5 illustrates an example process flow 500 for communicating content brightness to a sink device 120. In some embodiments, the illustrated process flow may be implemented by the source device 110. In particular, the process flow may be implemented using any combination of hardware and/or software on the source device 110, such as a GPU 112, a display engine, and/or an associated graphics driver. For example, the graphics driver can utilize the GPU 112 and/or display engine to analyze frames 102 at lower power and efficiently determine the content type and maximum luminance for each frame. Alternatively, the process flow may be implemented by an operating system (OS) and/or an application executing on the source device (e.g., on a CPU 116). In other embodiments, the illustrated process flow may be implemented directly on the sink device 120.

The process flow begins at block 502 by enabling HDR mode. In some embodiments, the source device 110 may send the sink device 120 an instruction to enable HDR mode. For example, the OS on the CPU 116 of the source device 110 may indicate to the timing controller (TCON) 122 on the sink device 120 whether the source device 110 is operating in SDR mode or HDR mode. Thus, when the source device 110 transitions from SDR mode to HDR mode, the OS on the source device 110 may instruct the TCON 122 on the sink device 120 to enter HDR mode.

As a result, the sink device 120 may transition its display panel 130 from SDR mode to HDR mode. Alternatively, in some embodiments, block 502 may be omitted, and the process flow may be implemented regardless of whether HDR mode is enabled (e.g., implemented in both SDR mode and HDR mode).

The process flow then proceeds to block 504 to detect the content type and brightest pixel in each frame. For example, the content type may be determined by analyzing each frame 102 using content detection techniques (e.g., artificial intelligence (AI) and/or machine learning (ML) models, such as a convolutional neural network (CNN), trained to recognize visual content). In some embodiments, the content type may indicate a category of content detected within the frame, such as a movie, video game, desktop productivity application, etc. In other embodiments, the content type may indicate a level of brightness associated with the content detected in the frame, such as high brightness, moderate brightness, low brightness, etc.

Moreover, the brightest pixel in each frame 102 may be identified by analyzing each pixel in the frame 102 and comparing the pixel brightness levels, or by analyzing a histogram of frame content 102 that includes pixel brightness data. Alternatively, in some embodiments, the content type and/or maximum pixel brightness in each frame 102 may be provided as metadata 104 associated with the frame content, thus eliminating the need to manually determine content type and/or maximum brightness. In some embodiments, for example, the frame content metadata 104 may include a maximum content light level (MaxCLL) parameter or the equivalent indicating the brightest pixel in each frame.

The process flow then proceeds to block 506 to determine the peak brightness or luminance (e.g., maximum pixel brightness) for a rolling window of N consecutive frames 102.

In some embodiments, for example, the rolling window may include a sequence of N pending frames 102 that are next to be displayed in the pipeline, where N is one or more. For example, for N=1, the peak brightness may be identified for the next pending frame 102 only (e.g., based on the brightest pixel identified for that frame 102 at block 504). As another example, for N=5, the peak brightness may be computed across the next 5 pending frames 102 (e.g., by comparing the brightness level of the brightest pixels identified in those 5 frames 102 at block 504).

Alternatively, the peak brightness may be determined at any another granularity, such as per scene (e.g., based on scene transitions identified in metadata 104 or using the content detection techniques in block 504).

The process flow then proceeds to block 508 to send brightness metadata 104 to the sink device 120. In some embodiments, for example, the brightness metadata 104 may include the content type (e.g., determined at block 504) and the peak brightness for the next N pending frames 102 (e.g., determined at block 506).

In some embodiments, the display controller 114 on the source device 110 may send the brightness metadata 104 to the timing controller (TCON) 122 on the sink device 120. In some embodiments, the brightness metadata 104 may be sent using a secondary data packet (SDP) of the DisplayPort protocol for an HDR session between the source/sink devices 110, 120 (e.g., using a maximum brightness metadata field, such as MaxCLL or the equivalent). In some embodiments, the brightness metadata 104 may only be sent to the sink device 120 whenever there is a change beyond certain thresholds or ranges defined for content type and brightness on the sink device 120 (e.g., when the peak brightness for the pending frames 102 exceeds the luminance range supported by the current power level the sink device 120 is operating at). In some embodiments, the source device 110 may use a multi-frame hysteresis-based approach to reduce frequent voltage swings, thus ensuring that voltage swings do not result in display flickers.

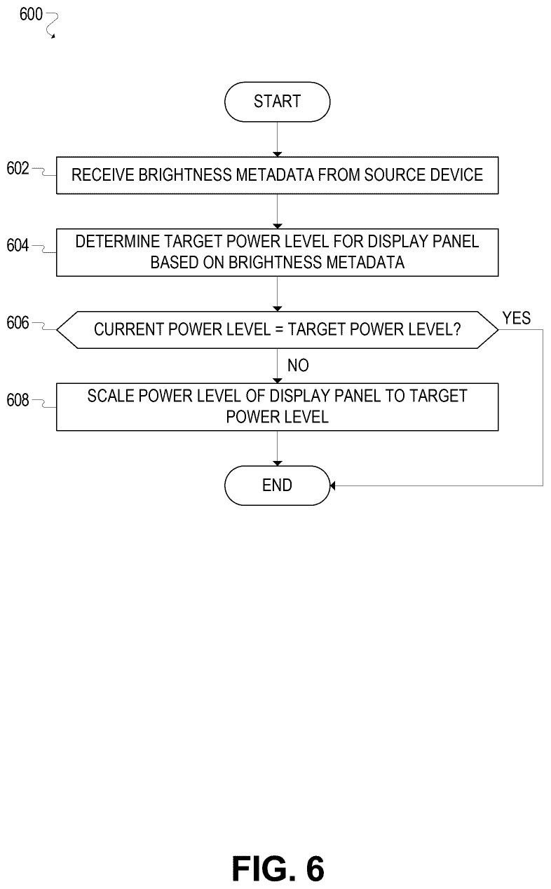

At this point, the process flow may be complete. In some embodiments, the sink device 120 may implement the process flow of FIG. 6 to dynamically scale the power level of the display panel 130 based on the brightness metadata 104, as described further below.

FIG. 6 illustrates an example process flow 600 for dynamically scaling the power level of a display panel 130 based on content brightness. In some embodiments, the illustrated process flow may be implemented by the sink device 120 using brightness metadata 104 provided by the source device 110 (e.g., from process flow 500). In particular, the process flow may be implemented by any combination of hardware and/or software on the sink device 120, such as the timing controller (TCON) 122, the power management unit (PMU) 124, any other circuitry on the sink device 120, and/or any associated firmware.

The process flow begins at block 602 by receiving brightness metadata 104 from the source device 110 (e.g., GPU). In some embodiments, the timing controller (TCON) 122 on the sink device 120 may receive the brightness metadata 104 from the display controller 114 on the source device 110.

The process flow then proceeds to block 604 to determine the target power level (e.g., operating voltage, duty cycle) for the display panel 130 based on the brightness metadata 104. In some embodiments, for example, the sink device 120 may have defined ranges of brightness/luminance and corresponding power levels. Moreover, the sink device 120 may determine which brightness/luminance range includes the maximum pixel brightness specified in the brightness metadata 104, and the sink device 120 may then identify the corresponding power level for that brightness/luminance range as the target power level. In some embodiments, the target power level may be determined by the TCON 122.

For example, a sink device 120 with an OLED display panel 130 may include defined brightness ranges and corresponding operating voltages (e.g., operating voltage V₀ for brightness of 0-250 nits, operating voltage V₁ for brightness of 251-620 nits, operating voltage V₂ for brightness of 621 or more nits).

As another example, a sink device 120 with an LCD display panel 130 may include defined brightness ranges and corresponding pulse-width modulation (PWM) duty cycles for the backlight of the LCD display panel 130 (e.g., 50% duty cycle for brightness of 0-250 nits, 75% duty cycle for brightness of 251-620 nits, 100% duty cycle for brightness of 621 or more nits).

Moreover, the sink device 120 may identify the brightness range that the maximum pixel brightness falls within, and the sink device 120 may then identify the corresponding operating voltage (e.g., for OLED) or duty cycle (e.g., for LCD) for the identified brightness range.

In other embodiments (e.g., for other types of display panels 130), other power-level settings may be used instead of operating voltage or duty cycle (e.g., electric current, among others).

The process flow then proceeds to block 606 to determine whether the current power level (e.g., operating voltage, duty cycle) of the display panel 130 is set to the target power level. In some embodiments, the TCON 122 may perform this determination.

For example, for an OLED display panel 130, the sink device 120 may determine whether the OLED display panel 130 is already operating at the target operating voltage. For an LCD display panel 130, the sink device 120 may determine whether the backlight of the LCD display panel 130 is already operating at the target duty cycle.

If the display panel 130 is already operating at the target power level identified at block 604, no power level adjustment is needed, and the process flow may be complete. In some embodiments, the process flow may restart at block 602 to continue receiving and processing brightness metadata 104 for pending frames.

If the display panel 130 is not already operating at the target power level, the process flow proceeds to block 608 to dynamically scale the power level of the display panel 130 to the target power level. In some embodiments, the power-level scaling may be collectively performed by the TCON 122 and the PMU 124 (e.g., the PMU 124 may scale the power level in response to an instruction 106 from the TCON 122).

For example, for an OLED display panel 130, the sink device 120 may scale the operating voltage of the OLED display panel 130 to the target operating voltage. For an LCD display panel 130, the sink device 120 may scale the duty cycle of the backlight of the LCD display 130 to the target duty cycle (e.g., by scaling the frequency of the PWM duty cycle signal).

At this point, the process flow may be complete. In some embodiments, however, the process flow may restart at block 602 to continue receiving brightness metadata 104 for pending frames and dynamically scaling the power level of the display panel 130, as appropriate.

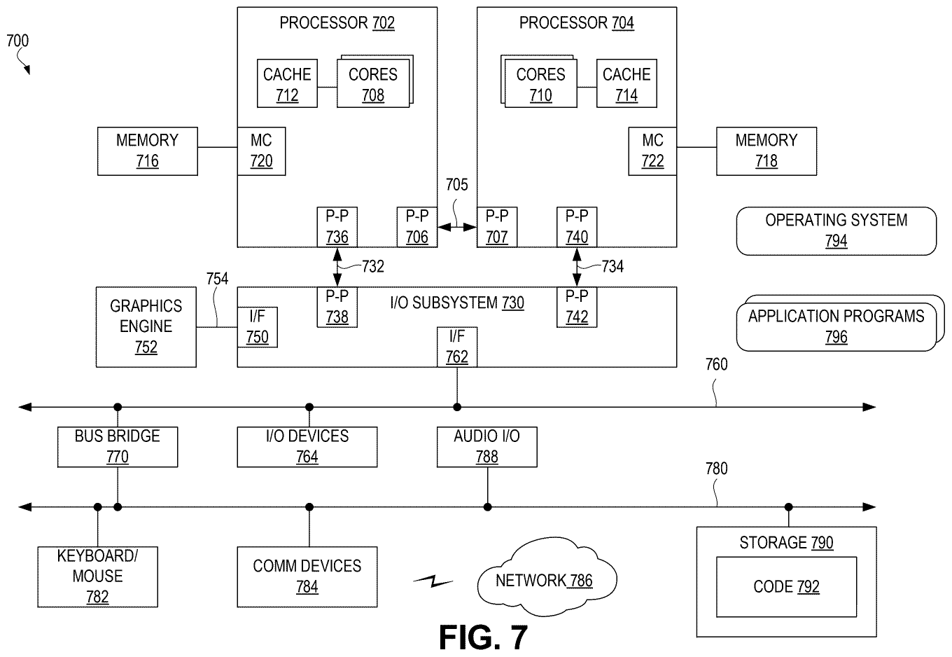

FIG. 7 illustrates an example computing system 700 in which technologies described herein may be implemented. In some embodiments, for example, system 700 may be used to implement system 100, processor 702, 704 may include CPU 116 and/or GPU 112, graphics engine 752 may include GPU 112 and/or display controller 114, and I/O devices 764 may include a display device (e.g., sink device 120 and associated display panel 130).

Generally, components shown in FIG. 7 can communicate with other shown components, although not all connections are shown, for ease of illustration. The computing system 700 is a multiprocessor system comprising first processor unit 702 and second processor unit 704 comprising point-to-point (P-P) interconnects. A point-to-point (P-P) interface 706 of the first processor unit 702 is coupled to a point-to-point interface 707 of the second processor unit 704 via a point-to-point interconnection 705. It is to be understood that any or all of the point-to-point interconnects illustrated in FIG. 7 can be alternatively implemented as a multi-drop bus, and that any or all buses illustrated in FIG. 7 could be replaced by point-to-point interconnects.

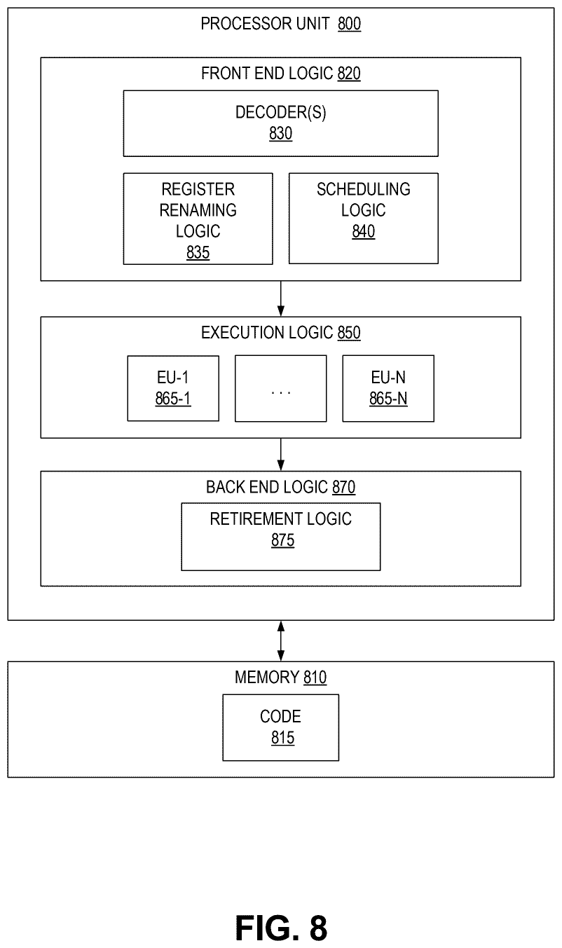

The first processor unit 702 and second processor unit 704 comprise multiple processor cores. The first processor unit 702 comprises processor cores 708 and the second processor unit 704 comprises processor cores 710. Processor cores 708 and 710 can execute computer-executable instructions in a manner similar to that discussed below in connection with FIG. 8, or other manners.

The first processor unit 702 and the second processor unit 704 further comprise cache memories 712 and 714, respectively. The cache memories 712 and 714 can store data (e.g., instructions) utilized by one or more components of the first processor unit 702 and the second processor unit 704, such as the processor cores 708 and 710. The cache memories 712 and 714 can be part of a memory hierarchy for the computing system 700. For example, the cache memories 712 can locally store data that is also stored in a first memory 716 to allow for faster access to the data by the first processor unit 702. In some embodiments, the cache memories 712 and 714 can comprise multiple cache memories that are a part of a memory hierarchy. The cache memories in the memory hierarchy can be at different cache memory levels, such as level 1 (L1), level 2 (L2), level 3 (L3), level 4 (L4), or other cache memory levels. In some embodiments, one or more levels of cache memory (e.g., L2, L3, L4) can be shared among multiple cores in a processor unit or among multiple processor units in an integrated circuit component. In some embodiments, the last level of cache memory in an integrated circuit component can be referred to as a last-level cache (LLC). One or more of the higher levels of cache levels (the smaller and faster cache memories) in the memory hierarchy can be located on the same integrated circuit die as a processor core and one or more of the lower cache levels (the larger and slower caches) can be located on one or more integrated circuit dies that are physically separate from the processor core integrated circuit dies.

Although the computing system 700 is shown with two processor units, the computing system 700 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 700 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 702 and the second processor unit 704 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 702 further comprises first memory controller logic (first MC 720) and the second processor unit 704 further comprises second memory controller logic (second MC 722). As shown in FIG. 7, a first memory 716 coupled to the first processor unit 702 is controlled by the first MC 720 and a second memory 718 coupled to the second processor unit 704 is controlled by the second MC 722. The first memory 716 and the second memory 718 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 716 and the second memory 718 can comprise one or more layers of a memory hierarchy of the computing system. While first MC 720 and second MC 722 are illustrated as being integrated into the first processor unit 702 and the second processor unit 704, in alternative embodiments, memory controller logic can be external to a processor unit.

The first processor unit 702 and the second processor unit 704 are coupled to an Input/Output subsystem 730 (I/O subsystem) via point-to-point interconnections 732 and 734. The point-to-point interconnection 732 connects a point-to-point interface 736 of the first processor unit 702 with a point-to-point interface 738 of the Input/Output subsystem 730, and the point-to-point interconnection 734 connects a point-to-point interface 740 of the second processor unit 704 with a point-to-point interface 742 of the Input/Output subsystem 730. Input/Output subsystem 730 further includes an interface 750 to couple the Input/Output subsystem 730 to a graphics engine 752. The Input/Output subsystem 730 and the graphics engine 752 are coupled via a bus 754.

The Input/Output subsystem 730 is further coupled to a first bus 760 via an interface 762. The first bus 760 can be a Peripheral Component Interconnect Express (PCIe) bus or any other type of bus. Various I/O devices 764 can be coupled to the first bus 760. A bus bridge 770 can couple the first bus 760 to a second bus 780. In some embodiments, the second bus 780 can be a low pin count (LPC) bus. Various devices can be coupled to the second bus 780 including, for example, a keyboard/mouse 782, audio I/O devices 788, and a storage device 790, such as a hard disk drive, solid-state drive, or another storage device for storing computer-executable instructions (or code 792) or data. The code 792 can comprise computer-executable instructions for performing methods described herein. Additional components that can be coupled to the second bus 780 include one or more communication devices 784, which can provide for communication between the computing system 700 and one or more wired or wireless networks 786 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 784 support wireless communication, the one or more communication devices 784 can comprise wireless communication components coupled to one or more antennas to support communication between the computing system 700 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The computing system 700 can comprise removable memory such as flash memory cards (e.g., SD (Secure Digital) cards), memory sticks, Subscriber Identity Module (SIM) cards). The memory in computing system 700 (including cache memories 712 and 714, first memory 716, second memory 718, and storage device 790) can store data and/or computer-executable instructions for executing an operating system 794 and application programs 796. Example data includes web pages, text messages, images, sound files, and video data, to be sent to and/or received from one or more network servers or other devices by the computing system 700 via the one or more wired or wireless networks 786, or for use by the computing system 700. The computing system 700 can also have access to external memory or storage (not shown) such as external hard drives or cloud-based storage.

The operating system 794 can control the allocation and usage of the components illustrated in FIG. 7 and support the application programs 796. The application programs 796 can include common computing system applications (e.g., email applications, calendars, contact managers, web browsers, messaging applications) as well as other computing applications, such as multimedia applications (e.g., for video playback/streaming).

In some embodiments, a hypervisor (or virtual machine manager) operates on the operating system 794 and the application programs 796 operate within one or more virtual machines operating on the hypervisor. In these embodiments, the hypervisor is a type-2 or hosted hypervisor as it is running on the operating system 794. In other hypervisor-based embodiments, the hypervisor is a type-1 or “bare-metal” hypervisor that runs directly on the platform resources of the computing system 700 without an intervening operating system layer.

In some embodiments, the application programs 796 can operate within one or more containers. A container is a running instance of a container image, which is a package of binary images for one or more of the application programs 796 and any libraries, configuration settings, and any other information that the application programs 796 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 794. An orchestrator can be responsible for management of the computing system 700 and various container-related tasks such as deploying container images to the computing system 700, monitoring the performance of deployed containers, and monitoring the utilization of the resources of the computing system 700.

The computing system 700 can support various additional input devices 764, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices 764, such as one or more speakers or displays. Other possible input and output devices 764 include piezoelectric and other haptic I/O devices. Any of the input or output devices can be internal to, external to, or removably attachable with the computing system 700. External input and output devices can communicate with the computing system 700 via wired or wireless connections.

In addition, the computing system 700 can provide one or more natural user interfaces (NUIs). For example, the operating system 794 or application programs 796 can comprise speech recognition logic as part of a voice user interface that allows a user to operate the computing system 700 via voice commands. Further, the computing system 700 can comprise input devices and logic that allows a user to interact with computing the computing system 700 via body, hand, or face gestures.

The computing system 700 can further include at least one input/output port comprising physical connectors (e.g., USB, FireWire, Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 700 can further comprise one or more additional antennas coupled to one or more additional receivers, transmitters, and/or transceivers to enable additional functions.

In addition to those already discussed, integrated circuit components, integrated circuit constituent components, and other components in the computing system 700 can communicate via interconnect technologies such as Intel® QuickPath Interconnect (QPI), Intel® Ultra Path Interconnect (UPI), Computer Express Link (CXL), cache coherent interconnect for accelerators (CCIX®), serializer/deserializer (SERDES), Nvidia® NVLink, ARM Infinity Link, Gen-Z, or Open Coherent Accelerator Processor Interface (OpenCAPI). Other interconnect technologies may be used and a computing system 700 may utilize more or more interconnect technologies.

It is to be understood that FIG. 7 illustrates only one example computing system architecture. Computing systems based on alternative architectures can be used to implement technologies described herein. For example, instead of the first processor unit 702, the second processor unit 704, and the graphics engine 752 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 7. Moreover, the illustrated components in FIG. 7 are not required or all-inclusive, as shown components can be removed and other components added in alternative embodiments.

FIG. 8 illustrates an example processor unit 800 to execute computer-executable instructions as part of implementing technologies described herein. In some embodiments, for example, processor unit 800 may include CPU 116 and/or GPU 112.

The processor unit 800 can be a single-threaded core or a multithreaded core in that it may include more than one hardware thread context (or “logical processor”) per processor unit.

FIG. 8 also illustrates a memory 810 coupled to the processor unit 800. The memory 810 can be any memory described herein or any other memory known to those of skill in the art. The memory 810 can store computer-executable instructions 815 (code) executable by the processor unit 800.

The processor unit comprises front-end logic 820 that receives instructions from the memory 810. An instruction can be processed by one or more decoders 830. The one or more decoders 830 can generate as its output a micro-operation such as a fixed width micro-operation in a predefined format, or generate other instructions, microinstructions, or control signals, which reflect the original code instruction. The front-end logic 820 further comprises register renaming logic 835 and scheduling logic 840, which generally allocate resources and queues operations corresponding to converting an instruction for execution.

The processor unit 800 further comprises execution logic 850, which comprises one or more execution units (EUs) (execution unit 865-1 through execution unit 865-N). Some processor unit embodiments can include a number of execution units dedicated to specific functions or sets of functions. Other embodiments can include only one execution unit or one execution unit that can perform a particular function. The execution logic 850 performs the operations specified by code instructions. After completion of execution of the operations specified by the code instructions, back-end logic 870 retires instructions using retirement logic 875. In some embodiments, the processor unit 800 allows out of order execution but requires in-order retirement of instructions. Retirement logic 875 can take a variety of forms as known to those of skill in the art (e.g., re-order buffers or the like).

The processor unit 800 is transformed during execution of instructions, at least in terms of the output generated by the one or more decoders 830, hardware registers and tables utilized by the register renaming logic 835, and any registers (not shown) modified by the execution logic 850.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The concepts described herein are illustrated by way of example and not by way of limitation in the accompanying drawings. For simplicity and clarity of illustration, elements illustrated in the drawings are not necessarily drawn to scale. Where considered appropriate, reference labels have been repeated among the drawings to indicate corresponding or analogous elements.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative drawings. Additionally, the inclusion of a structural or method feature in a particular drawing is not meant to imply that such feature is required in all embodiments and, in some embodiments, may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

A list of items joined by the term “and/or” can mean any combination of the listed items. For example, the phrase “A, B and/or C” can mean A; B; C; A and B; A and C; B and C; or A, B and C. A list of items joined by the term “at least one of” can mean any combination of the listed terms. For example, the phrase “at least one of A, B or C” can mean A; B; C; A and B; A and C; B and C; or A, B, and C. Moreover, a list of items joined by the term “one or more of” can mean any combination of the listed terms. For example, the phrase “one or more of A, B and C” can mean A; B; C; A and B; A and C; B and C; or A, B, and C.

The technologies described herein can be performed by or implemented in any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, or multiple machine-readable storage media, which may be read and executed by one or more machines (e.g., computers, processors, etc.). A machine-readable storage medium may be embodied as any storage device, mechanism, or other physical structure for storing or transmitting information in a form readable by a machine (e.g., a volatile or non-volatile memory, a media disc, or other media device).

### EXAMPLES

The following examples pertain to embodiments of technologies disclosed herein.

Example 1 includes an electronic device, comprising: a display panel; and control circuitry to: receive a sequence of frames, wherein the sequence of frames comprises a plurality of frames to be displayed sequentially on the display panel; and dynamically adjust a power level for the display panel based on brightness data for the sequence of frames.

Example 2 includes the electronic device of Example 1, wherein the control circuitry to dynamically adjust the power level for the display panel based on the brightness data for the sequence of frames is further to: determine whether high dynamic range (HDR) mode is enabled; and upon determining that HDR mode is enabled, dynamically adjust the power level for the display panel based on the brightness data for the sequence of frames.

Example 3 includes the electronic device of any one of Examples 1-2, wherein: the power level comprises an operating voltage for the display panel; and the control circuitry to dynamically adjust the power level for the display panel based on the brightness data for the sequence of frames is further to: dynamically adjust the operating voltage for the display panel based on the brightness data for the sequence of frames.

Example 4 includes the electronic device of Example 3, wherein the display panel is an organic light-emitting diode (OLED) display panel.

Example 5 includes the electronic device of any one of Examples 1-2, wherein: the power level comprises a duty cycle for the display panel; and the control circuitry to dynamically adjust the power level for the display panel based on the brightness data for the sequence of frames is further to: dynamically adjust the duty cycle for the display panel based on the brightness data for the sequence of frames.

Example 6 includes the electronic device of Example 5, wherein the duty cycle comprises a pulse width modulation (PWM) duty cycle for a backlight of the display panel.

Example 7 includes the electronic device of Example 6, wherein the display panel is a liquid crystal display (LCD) display panel.

Example 8 includes the electronic device of any one of Examples 1-7, wherein the brightness data indicates a maximum pixel brightness for the sequence of frames.

Example 9 includes the electronic device of Example 8, wherein the brightness data further indicates the maximum pixel brightness for a rolling window of frames, wherein the rolling window of frames comprises one or more pending frames to be displayed next from the sequence of frames.

Example 10 includes the electronic device of any one of Examples 8-9, wherein the brightness data further indicates a content type for the sequence of frames.

Example 11 includes the electronic device of any one of Examples 1-10, wherein the control circuitry comprises a timing controller.

Example 12 includes the electronic device of Example 11, wherein the control circuitry further comprises a power management unit.

Example 13 includes the electronic device of any one of Examples 1-12, further comprising interface circuitry, wherein the control circuitry to receive the sequence of frames is further to: receive, via the interface circuitry, the sequence of frames and the brightness data from a display controller.

Example 14 includes the electronic device of Example 13, wherein the display controller is comprised in a graphics processing unit (GPU).

Example 15 includes a system, comprising: source circuitry to send, to sink circuitry, a plurality of frames and brightness data for the plurality of frames, wherein the plurality of frames are to be displayed sequentially on a display panel; and the sink circuitry to: receive, from the source circuitry, the plurality of frames and the brightness data; dynamically adjust a voltage for the display panel based on the brightness data for the plurality of frames; and cause the plurality of frames to be displayed sequentially on the display panel.

Example 16 includes the system of Example 15, wherein the sink circuitry to dynamically adjust the voltage for the display panel based on the brightness data for the plurality of frames is further to: determine whether high dynamic range (HDR) mode is enabled; and upon determining that HDR mode is enabled, dynamically adjust the voltage for the display panel based on the brightness data for the plurality of frames.

Example 17 includes the system of any one of Examples 15-16, wherein: the voltage comprises an operating voltage for the display panel, wherein the display panel is an organic light-emitting diode (OLED) display panel; or the voltage comprises an average voltage for a backlight of the display panel, wherein the average voltage is based on a duty cycle for the backlight of the display panel, wherein the display panel is a liquid crystal display (LCD) display panel.

Example 18 includes the system of any one of Examples 15-17, wherein the brightness data indicates a maximum pixel brightness for one or more of the plurality of frames.

Example 19 includes the system of Example 18, wherein the brightness data further indicates a content type for one or more of the plurality of frames.

Example 20 includes the system of Example 19, wherein the source circuitry is further to determine at least one of the maximum pixel brightness or the content type.

Example 21 includes the system of Example 20, wherein the source circuitry comprises a graphics processing unit (GPU) and a display controller, wherein: the GPU is to determine at least one of the maximum pixel brightness or the content type; and the display controller is to send, to the sink circuitry, the plurality of frames and the brightness data.

Example 22 includes the system of Example 21, wherein the display controller is comprised in the GPU.

Example 23 includes the system of any one of Examples 15-22, wherein the sink circuitry comprises a timing controller and a power management unit.

Example 24 includes the system of Example 23, wherein the sink circuitry further comprises the display panel.

Example 25 includes a method, comprising: receiving, via interface circuitry, a plurality of frames, wherein the plurality of frames are to be displayed sequentially on a display panel; and continuously adjusting a power level for the display panel based on luminance data for one or more pending frames, wherein the one or more pending frames are next to be displayed from the plurality of frames.

Example 26 includes the method of Example 25, wherein continuously adjusting the power level for the display panel based on the luminance data for the one or more pending frames comprises: determining whether high dynamic range (HDR) mode is enabled; and upon determining that HDR mode is enabled, continuously adjusting the power level for the display panel based on the luminance data for the one or more pending frames.

Example 27 includes the method of any one of Examples 25-26, wherein: the power level comprises an operating voltage for the display panel; and continuously adjusting the power level for the display panel based on the luminance data for the one or more pending frames comprises: continuously adjusting the operating voltage for the display panel based on the luminance data for the one or more pending frames.

Example 28 includes the method of Example 27, wherein the display panel is an organic light-emitting diode (OLED) display panel.

Example 29 includes the method of any one of Examples 25-26, wherein: the power level comprises a duty cycle for the display panel; and continuously adjusting the power level for the display panel based on the luminance data for the one or more pending frames comprises: continuously adjusting the duty cycle for the display panel based on the luminance data for the one or more pending frames.

Example 30 includes the method of Example 29, wherein the duty cycle comprises a pulse width modulation (PWM) duty cycle for a backlight of the display panel.

Example 31 includes the method of Example 30, wherein the display panel is a liquid crystal display (LCD) display panel.

Example 32 includes the method of any one of Examples 25-31, wherein the luminance data indicates a maximum pixel brightness for the one or more pending frames.

Example 33 includes the method of Example 32, further comprising determining the maximum pixel brightness for the one or more pending frames.

Example 34 includes the method of any one of Examples 25-33, wherein the luminance data indicates a content type for the one or more pending frames.

Example 35 includes the method of Example 34, further comprising determining the content type for the one or more pending frames.

Example 36 includes one or more computer-readable storage media storing computer-executable instructions that, when executed, cause a computer to perform a method, the method comprising: receiving, via interface circuitry, a plurality of frames, wherein the plurality of frames are to be displayed sequentially on a display panel; and continuously adjusting a power level for the display panel based on luminance data for one or more pending frames, wherein the one or more pending frames are next to be displayed from the plurality of frames.

Example 37 includes the one or more computer-readable storage media of Example 36, wherein continuously adjusting the power level for the display panel based on the luminance data for the one or more pending frames comprises: determining whether high dynamic range (HDR) mode is enabled; and upon determining that HDR mode is enabled, continuously adjusting the power level for the display panel based on the luminance data for the one or more pending frames.

Example 38 includes the one or more computer-readable storage media of any one of Examples 36-37, wherein: the power level comprises an operating voltage for the display panel; and continuously adjusting the power level for the display panel based on the luminance data for the one or more pending frames comprises: continuously adjusting the operating voltage for the display panel based on the luminance data for the one or more pending frames.

Example 39 includes the one or more computer-readable storage media of Example 38, wherein the display panel is an organic light-emitting diode (OLED) display panel.

Example 40 includes the one or more computer-readable storage media of any one of Examples 36-37, wherein: the power level comprises a duty cycle for the display panel; and continuously adjusting the power level for the display panel based on the luminance data for the one or more pending frames comprises: continuously adjusting the duty cycle for the display panel based on the luminance data for the one or more pending frames.

Example 41 includes the one or more computer-readable storage media of Example 40, wherein the duty cycle comprises a pulse width modulation (PWM) duty cycle for a backlight of the display panel.

Example 42 includes the one or more computer-readable storage media of Example 41, wherein the display panel is a liquid crystal display (LCD) display panel.

Example 43 includes the one or more computer-readable storage media of any one of Examples 36-42, wherein the luminance data indicates a maximum pixel brightness for the one or more pending frames.

Example 44 includes the one or more computer-readable storage media of Example 43, further comprising determining the maximum pixel brightness for the one or more pending frames.

Example 45 includes the one or more computer-readable storage media of any one of Examples 36-44, wherein the luminance data indicates a content type for the one or more pending frames.

Example 46 includes the one or more computer-readable storage media of Example 45, further comprising determining the content type for the one or more pending frames.

Example 47 includes one or more computer-readable storage media storing computer-executable instructions that, when executed, cause a computer to perform the method of any one of Examples 25-35.

Example 48 includes an apparatus comprising means to perform the method of any one of Examples 25-35.

Example 49 includes a system comprising means to perform the method of any one of Examples 25-35.

1. An electronic device, comprising:
a display panel; and
control circuitry to:
receive a sequence of frames, wherein the sequence of frames comprises a plurality of frames to be displayed sequentially on the display panel, wherein the respective frames comprise a plurality of pixel brightness values for a plurality of pixels; and
dynamically adjust a power level for the display panel based on brightness data for the sequence of frames, wherein the brightness data indicates a maximum pixel brightness value of the pixel brightness values in one or more of the frames.

2. The electronic device of claim 1, wherein the control circuitry to dynamically adjust the power level for the display panel based on the brightness data for the sequence of frames is further to:
determine whether high dynamic range (HDR) mode is enabled; and
upon determining that HDR mode is enabled, dynamically adjust the power level for the display panel based on the brightness data for the sequence of frames.

3. The electronic device of claim 1, wherein:
the power level comprises an operating voltage for the display panel; and
the control circuitry to dynamically adjust the power level for the display panel based on the brightness data for the sequence of frames is further to:
dynamically adjust the operating voltage for the display panel based on the brightness data for the sequence of frames.

4. The electronic device of claim 3, wherein the display panel is an organic light-emitting diode (OLED) display panel.

5. The electronic device of claim 1, wherein:
the power level comprises a duty cycle for the display panel; and
the control circuitry to dynamically adjust the power level for the display panel based on the brightness data for the sequence of frames is further to:
dynamically adjust the duty cycle for the display panel based on the brightness data for the sequence of frames.

6. The electronic device of claim 5, wherein the duty cycle comprises a pulse width modulation (PWM) duty cycle for a backlight of the display panel.

7. The electronic device of claim 6, wherein the display panel is a liquid crystal display (LCD) display panel.

8. (canceled)

9. The electronic device of claim 1, wherein the brightness data further indicates the maximum pixel brightness value of the pixel brightness values in a rolling window of frames, wherein the rolling window of frames comprises one or more pending frames to be displayed next from the sequence of frames.

10. The electronic device of claim 1, wherein the brightness data further indicates a content type for the sequence of frames.

11. A system, comprising:
source circuitry to send, to sink circuitry, a plurality of frames and brightness data for the plurality of frames, wherein the plurality of frames are to be displayed sequentially on a display panel, wherein the respective frames comprise a plurality of pixel brightness values for a plurality of pixels, and wherein the brightness data indicates a maximum pixel brightness value of the pixel brightness values in one or more of the frames; and
the sink circuitry to:
receive, from the source circuitry, the plurality of frames and the brightness data;
dynamically adjust a voltage for the display panel based on the brightness data for the plurality of frames; and
cause the plurality of frames to be displayed sequentially on the display panel.

12. The system of claim 11, wherein:
the voltage comprises an operating voltage for the display panel, wherein the display panel is an organic light-emitting diode (OLED) display panel; or
the voltage comprises an average voltage for a backlight of the display panel, wherein the average voltage is based on a duty cycle for the backlight of the display panel, wherein the display panel is a liquid crystal display (LCD) display panel.

13. (canceled)

14. The system of claim 11, wherein the brightness data further indicates a content type for one or more of the plurality of frames.

15. The system of claim 14, wherein the source circuitry is further to determine at least one of the maximum pixel brightness value or the content type.

16. The system of claim 15, wherein the source circuitry comprises a graphics processing unit (GPU) and a display controller, wherein:
the GPU is to determine at least one of the maximum pixel brightness value or the content type; and
the display controller is to send, to the sink circuitry, the plurality of frames and the brightness data.

17. The system of claim 11, wherein the sink circuitry comprises a timing controller and a power management unit.

18. One or more non-transitory computer-readable storage media storing computer-executable instructions that, when executed, cause a computer to perform a method, the method comprising:
receiving, via interface circuitry, a plurality of frames, wherein the plurality of frames are to be displayed sequentially on a display panel, wherein the respective frames comprise a plurality of pixel brightness values for a plurality of pixels; and
continuously adjusting a power level for the display panel based on luminance data for one or more pending frames, wherein the one or more pending frames are next to be displayed from the plurality of frames, and wherein the luminance data indicates a maximum pixel brightness value of the pixel brightness values in the one or more pending frames.

19. The one or more non-transitory computer-readable storage media of claim 18, wherein:
the power level comprises an operating voltage for the display panel; and
continuously adjusting the power level for the display panel based on the luminance data for the one or more pending frames comprises:
continuously adjusting the operating voltage for the display panel based on the luminance data for the one or more pending frames.

20. The one or more non-transitory computer-readable storage media of claim 18, wherein:
the power level comprises a duty cycle for the display panel; and
continuously adjusting the power level for the display panel based on the luminance data for the one or more pending frames comprises:
continuously adjusting the duty cycle for the display panel based on the luminance data for the one or more pending frames.

21. The electronic device of claim 1, wherein the power level is adjusted to a level sufficient to support the maximum pixel brightness value.
